(19) United States
(12) Patent Application Publication
(10) Pub. No.: US 2025/0039222 A1
(43) Pub. Date: Jan. 30, 2025

(54) CYBERSECURITY THREAT HUNTING

(71) Applicant: Secure Cyber Defense, LLC, Moraine, OH (US)

(72) Inventors: Shawn WALDMAN, Miamisburg, OH (US); Joseph TINNEY, III, Miamisburg, OH (US); Edward CRISPEN, Fairborn, OH (US); Myles LISTER, Dayton, OH (US)

(21) Appl. No.: 18/774,270

(22) Filed: Jul. 16, 2024

Related U.S. Application Data
(60) Provisional application No. 63/528,439, filed on Jul. 24, 2023.
(60) Provisional application No. 63/642,282, filed on May 3, 2024.

(51) Int. Cl. H04L 9/40

(52) U.S. Cl. CPC H04L 63/1433; H04L 63/1441

(57) ABSTRACT

Methods, systems, and computer program products for implementing a cybersecurity threat hunting process at a device associated with a security orchestration, automation, and response (SOAR) platform. A plurality of intelligence feeds are obtained from an intelligence feed network. A campaign is determined for the plurality of intelligence feeds based on one or more campaign parameters. An indicator of compromise (IOC) hunt is initiated by determining a set of first search data from the plurality of intelligence feeds using a threat analysis process. One or more IOCs for the set of first search data are identified at a customer log database. A cybersecurity alert is generated based on the identified one or more IOCs. One or more customer devices are identified associated with each of the one or more identified IOCs. Whether to perform one or more remedial actions for each customer device associated with an identified IOC is determined.

### CROSS-REFERENCE TO RELATED APPLICATIONS

This application claims priority to U.S. Provisional Application Ser. No. 63/528,439 filed on Jul. 24, 2023 and U.S. Provisional Application Ser. No. 63/642,282 filed on May 3, 2024, the entire disclosures of which are hereby incorporated by reference.

### TECHNICAL FIELD

The present invention generally relates to computers and computer software, and more specifically, to methods, systems, and computer program products for implementing a cybersecurity threat hunting process.

### BACKGROUND

The field of information technology has continued to develop different strategies to address new security issues because of the rapid evolution of cyber threats. For example, modern Security Operation Centers (SOCs) employ “playbooks” to help automate steps of a workflow performed by an analyst to enrich, triage, and/or remediate an incident. Playbooks may include “plays” that may be represented in the form of complex queries that can be run against data including alerts from security products and activity logs from network and endpoint devices, network metadata, and full/partial packet captures.

SOC analysts largely follow procedures for investigation of a particular type of incident on a security orchestration, automation and response (SOAR) platform, where outcomes of executed steps aid in determining the next step. The lifecycle of an incident in a SOAR platform involves multiple stages including, but not limited to, ingestion, enrichment, triaging, and remediation. As each phase includes a multi-step process and next steps are largely defined based on outcomes of previously executed one or multiple steps, automating the procedures into canned playbooks becomes complex.

A playbook building interface of a SOAR platform includes steps, routes, and decisions and forms/variables that provide input to the steps. The process of creating a playbook using traditional techniques can be tedious, especially when a user does not have a well-defined process that they are automating. In addition, there is a learning curve for turning SOC processes into working playbooks. When there are different types of incidents to automate, the development process of playbooks can slow down progress towards automation. Further, any new incident types that are observed at the SOC may require a new playbook development cycle, which may not work in the same manner as the incidents that already have a playbook. Therefore, there is a need for developing an intelligent approach for automating generation of playbooks for various incidents. Moreover, some of the prior techniques use multiple different tools to analyze and triage cyber threats and attacks that would require analysts to have to jump from tool to tool and follow different processes. Therefore, improved solutions for unifying and integrating cybersecurity services and tools to automate cyberattack prevention and response are needed.

### SUMMARY

In embodiments of the invention, a method for cybersecurity threat hunting. The method, at an electronic device associated with a security orchestration, automation, and response (SOAR) platform and having a processor, includes the actions of obtaining a plurality of intelligence feeds from an intelligence feed network. The method further includes the actions of determining a campaign for the plurality of intelligence feeds based on one or more campaign parameters associated with a customer. The method further includes the actions of initiating, based on search parameters associated with the campaign, an indicator of compromise (IOC) hunt for the customer by determining a set of first search data from the plurality of intelligence feeds using a threat analysis process. The method further includes the actions of identifying, based on the IOC hunt, one or more IOCs for the set of first search data at a customer log database associated with the customer. The method further includes the actions of generating a cybersecurity alert based on the identified one or more IOCs. The method further includes the actions of identifying one or more customer devices associated with each of the one or more identified IOCs. The method further includes the actions of determining whether to perform one or more remedial actions for each customer device associated with an identified IOC.

These and other embodiments can each optionally include one or more of the following features.

In some embodiments of the invention, the one or more remedial actions includes at least one of isolating an endpoint associated with each customer device, disabling a user account associated with each customer device, and blocking an IP address associated with a source of the identified one or more IOCs.

In some embodiments of the invention, the method further includes the actions of providing the cybersecurity alert to an application interface at a user device.

In some embodiments of the invention, identifying the one or more IOCs for the set of first search data at the customer log database associated with the customer via the threat analysis process is based on determining relevant IOC context associated with the plurality of intelligence feeds. In some embodiments of the invention, the relevant IOC context includes an article link, malware information, a threat actor, common vulnerabilities and exposures (CVE) information, product information, an IP Address, file hash information, a domain, a URL, detection signatures, an email address, network port data, registry key data, tactics, techniques, and procedures (TTP) information, or a combination thereof.

In some embodiments of the invention, the one or more campaign parameters includes a hunt trigger event, and wherein the IOC hunt is initiated based on the hunt trigger event. In some embodiments of the invention, the hunt trigger event is based on a predetermined schedule, and wherein the IOC hunt is initiated for an identified timeframe. In some embodiments of the invention, the hunt trigger event is based on receiving a cybersecurity threat hunt request from a user device.

In some embodiments of the invention, determining the set of first search data from the plurality of intelligence feeds using the threat analysis process based on the search parameters associated with the campaign includes determining whether the intelligence feeds are associated with a first feed type or a second feed type that is different than the first feed type. In some embodiments of the invention, in response to identifying the feed type as a first feed type, the threat analysis process: i) builds query parameters based on an industry associated with the campaign, and ii) identifies search data repository platforms based on the query parameters. In some embodiments of the invention, in response to identifying the feed type as a second feed type, the threat analysis process identifies search data repository platforms. In some embodiments of the invention, the first feed type includes an industry feed or a customer feed, and wherein the second feed type includes a general feed.

In some embodiments of the invention, generating the cybersecurity alert based on the identified one or more IOCs includes determining commonality attributes associated with the identified one or more IOCs, and updating the cybersecurity alert based on the determined commonality attributes.

In some embodiments of the invention, generating the cybersecurity alert based on the identified one or more IOCs includes determining a cybersecurity threat level based on the identified one or more IOCs, and updating the cybersecurity alert based on the determined cybersecurity threat level.

In some embodiments of the invention, in response to determining that the cybersecurity threat level exceeds a threshold, the method further includes the actions of isolating an endpoint associated with the identified one or more IOCs, disabling a user account associated with the identified one or more IOCs, blocking an IP address associated with the identified one or more IOCs, performing additional remedial actions with an entity associated with the identified one or more IOCs, or a combination thereof.

In some embodiments of the invention, generating the cybersecurity alert based on the identified one or more IOCs includes determining a type of cybersecurity threat based on the identified one or more IOCs, and updating the cybersecurity alert based on the determined type of cybersecurity threat.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1A illustrates an exemplary system environment for implementing a process for cybersecurity threat hunting, according to embodiments of the invention.

FIG. 1B illustrates an exemplary system flow diagram for the exemplary system environment of FIG. 1A, according to embodiments of the invention.

FIG. 1C illustrates an exemplary flowchart of an example process for the system flow diagram of FIG. 1B, according to embodiments of the invention.

FIG. 2 illustrates an example intelligence feed of a threat intelligence report document, according to embodiments of the invention.

FIG. 3 illustrates an example environment for blocking an identified cybersecurity threat to a customer environment, according to embodiments of the invention.

FIG. 4 illustrates an example flow diagram of an example process for cybersecurity threat hunting, according to embodiments of the invention.

FIGS. 5-7 illustrate example screenshots for cybersecurity threat hunting processes via a cybersecurity threat hunting user interface, according to embodiments of the invention.

FIG. 8 is a flowchart of an example process for cybersecurity threat hunting, according to embodiments of the invention.

FIG. 9 is a block diagram showing an example computer architecture for a computer capable of executing the software components described herein, according to embodiments described herein.

### DETAILED DESCRIPTION

In some embodiments of the invention, the technology is related to systems and methods for implementing a cybersecurity threat hunting process based on receiving open-sourced intelligence feeds (e.g., filtered web traffic). In short, the cybersecurity threat hunting process is based on a SOAR platform that ingests flagged indicators of compromise (IOCs) and relevant context from the intelligence feeds. The IOC context may include the article link, and, if available, malware information, information identifying a threat actor, common vulnerabilities and exposures (CVE) information, product information, an internet protocol (IP) address, file hash information, a domain, an address of a given unique resource on the web such as a uniform resource locator (URL), detection signatures, an email address, network port data, registry key data, tactics, techniques, and procedures (TTP) information, or a combination thereof.

Some embodiments of the invention include software programs and graphical user interfaces (GUIs) for managing the system based on a cybersecurity threat hunting process on a SOAR platform. In an exemplary embodiment of the cybersecurity threat hunting process, intelligence feeds are ingested (e.g., open-sourced intelligence feeds are continuously obtained), and campaigns are created by a campaign module using the IOCs ingested into the SOAR platform (e.g., automatically and iteratively-daily, hourly, etc.). The campaign module then provides the campaign information and the IOC data to a hunt module to initiate a “hunt” (also referred to as an “IOC hunt”), which may be started on each feed based on the campaign parameters to search for IOCs at one or more customer's log databases. The found IOCs at the customer log databases are then provided to an alert module and alerts on potential threats are flagged, stored in an alert database, and analyzed (e.g., confidence levels rated, commonalities between threats (e.g., industries), etc.). Additionally, actions may be taken by one or more remediation modules based on confidence levels (e.g., isolate endpoints, disable user account, block an IP address, and/or other remedial actions that may be automatically processed or flagged for an end user, such as an analyst).

More specifically, this technology includes a cybersecurity threat hunting method, at an electronic device having a processor, that includes obtaining, at a SOAR platform server, a plurality of intelligence feeds from an intelligence feed network (e.g., threat intelligence data is continuously collected from threat intelligence sources). The method may further include determining a campaign for the plurality of intelligence feeds based on one or more campaign parameters associated with a customer (e.g., campaigns are created using IOCs ingested into the SOAR platform and may be automatically and/or iteratively updated daily, hourly, etc.). The method may further include initiating, by the SOAR platform server and based on search parameters associated with the campaign, an IOC hunt for the customer by determining a set of first search data from the plurality of intelligence feeds using a threat analysis process (e.g., IOC hunt is started for a particular time period, e.g., each day, hour, etc.). The IOC hunt searches customer log databases for the IOCs obtained from the intelligence feed network. In some implementations, the search parameters may vary based on the feed type, i.e., general, industry, customer, etc. For example, if an industry or customer feed the threat analysis method may build query parameters based on the associated industry and search data repository platforms using those query parameters, and if the intelligence feed is a general feed, the method searches data repository platforms for all customers. In some implementations, the IOC hunt may be automatically initiated based on a schedule or triggered by an analyst, customer, the SOAR platform, and the like.

The method may further include identifying, by the SOAR platform server, one or more IOCs for the set of first search data at a customer log database associated with the customer (e.g., IOC context may include an article link, and, if available, malware, threat actor, common vulnerabilities and exposures (CVE), product, and tactics, techniques, and procedures (TTP) information). The method may further include generating, by the SOAR platform server, a cybersecurity alert based on the identified one or more IOCs (e.g., all alerts on potential threats are flagged and analyzed: confidence levels rated, commonalities between threats (e.g., industries), etc.). The method may further include identifying, by the SOAR platform server, one or more customer devices associated with each of the one or more identified IOCs. The method may further include determining, by the SOAR platform server (e.g., a remediation module), whether to perform one or more remedial actions for each customer device associated with an identified IOC. For example, the one or more remedial actions may include at least one of isolating an endpoint associated with each customer device, disabling a user account associated with each customer device, and/or blocking an IP address associated with a source of the identified one or more IOCs.

In some implementations, the method may further include providing, by the SOAR platform server, the alert to an application interface at the user device (e.g., provide the alert to an analyst or to customer). In some implementations, the alert process may also determine a confidence level for the type of alert such as uncommon, multiple similar alerts or distinct cases, cross-industry alerts, etc., and based on the confidence level, the system may automatically perform remedial actions such as isolate the endpoint, disable user account, block IP sent to SOAR, and other remedial actions.

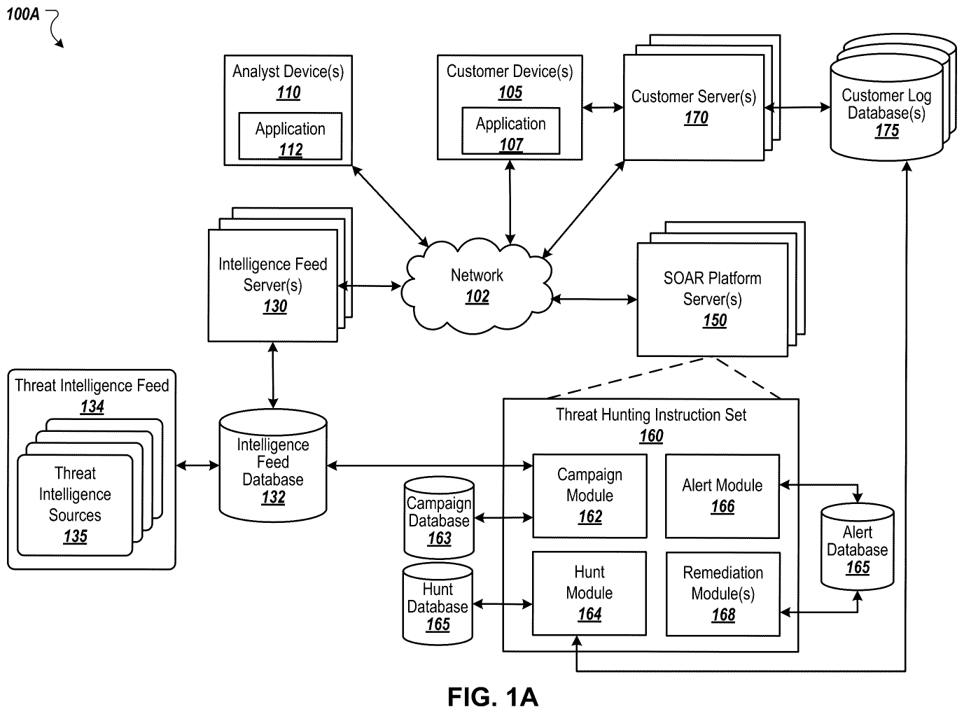

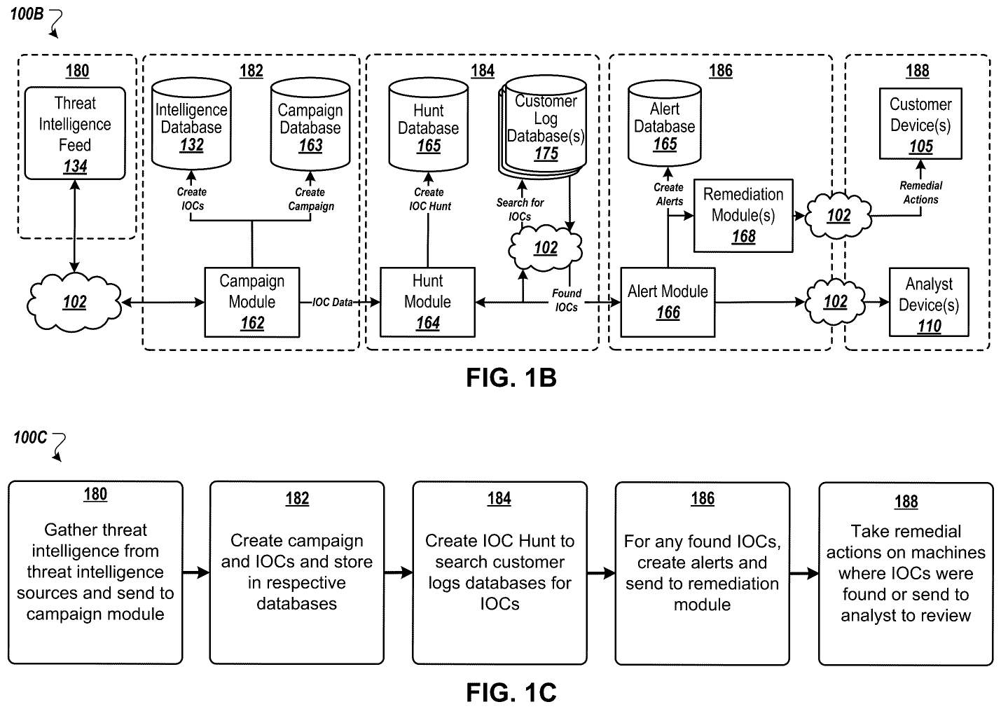

FIGS. 1A-1C illustrate example implementations of a cybersecurity threat hunting process, according to embodiments of the invention. FIG. 1A illustrates an example system environment 100A that includes a customer device 105, an analyst device 110, one or more intelligence feed server(s) 130, one or more customer server(s) 170, and one or more SOAR platform server(s) 150, that communicate over a data communication network 102, e.g., a local area network (LAN), a wide area network (WAN), the Internet, a mobile network, or a combination thereof.

The customer device 105 (e.g., an electronic device used by a customer, such as a customer requesting threat intelligence analysis and security from potential cyber threats) and the analyst device 110 (e.g., an electronic device used by a security analyst) can include a desktop, a laptop, a server, or a mobile device, such as a smartphone, tablet computer, and/or other types of electronic devices. The customer device 105 includes applications, such as the application 107, for allowing access and managing actions from the one or more SOAR platform server(s) 150, such as remedial actions from a cybersecurity threat hunt process. The analyst device 110 includes applications, such as the application 112, for managing a cybersecurity threat hunt process between the one or more intelligence feed server(s) 130 and the one or more SOAR platform server(s) 150. The customer device 105 or the analyst device 110 can include other applications. The customer device 105 (e.g., a customer) or the analyst device 110 (e.g., an analyst) may initiate a cybersecurity threat hunt request (e.g., an IOC hunt request) via application 107, 112 respectively.

In some implementations of the invention, a gateway (not illustrated) may be utilized to manage the location of threat hunting requests received from an application from the one or more users (e.g., several different analysts) and cybersecurity threat hunt requests received from application 112 from the one or more analyst devices 110 or from application 107 from the one or more customer devices 105. The management protocols of a gateway server may be based on a redundant load-balancing system by managing multiple clients (e.g., customer device(s) 105, analyst device(s) 110, etc.) so that a cybersecurity threat hunt request is handled by one of the one or more SOAR platform server(s) 150. For example, there may be multiple SOAR platform server(s) 150 that are able to service the cybersecurity threat hunt request, and the redundant load-balancing system of the gateway server is responsible for ensuring that the cybersecurity threat hunt request is performed by one of the capable SOAR platform servers 150. The gateway may be a front-end server for managing, collecting, processing, and communicating cybersecurity threat hunts, intelligence feed information, and the like between the one or more intelligence feed server(s) 130 and one or more SOAR platform server(s) 150 to the customer devices 105 via application 107 and/or analyst devices 110 via application 112 (e.g., via an application programming interface (API) orchestration).

The one or more intelligence feed server(s) 130 (e.g., electronic devices such as servers) can include a desktop, a laptop, a server, a cloud-based computing server farm, and the like. The one or more intelligence feed server(s) 130 receive and analyze a plurality of threat intelligence sources 135 from a threat intelligence feed 134 (e.g., cybersecurity articles from web traffic) stored in the intelligence feed database 132 in order to identify and flag indicators of compromise (IOCs) (e.g., an artifact observed on a network or in an operating system that indicates a computer intrusion) and relevant context. The IOC relevant context may include an article link, and, if available, malware information, information identifying a threat actor, common vulnerabilities and exposures (CVE) information, product information, an internet protocol (IP) address, file hash information, a domain, an address of a given unique resource on the web such as a uniform resource locator (URL), detection signatures, an email address, network port data, registry key data, tactics, techniques, and procedures (TTP) information, or a combination thereof. The one or more intelligence feed server(s) 130 may generate intelligence feeds based on one or more artificial intelligent protocols (e.g., machine learning cybersecurity protocols) that identify IOCs and other relevant data. The intelligence feeds may then be stored in the intelligence feed database 132. The intelligence feeds may be provided to the one or more SOAR platform server(s) 150 in response to a cybersecurity threat hunting request.

The one or more customer server(s) 170 (e.g., electronic devices such as servers) can include a desktop, a laptop, a server, a cloud-based computing server farm, and the like. The one or more customer server(s) 170 receives and processes, via the cybersecurity threat hunting instruction set 160, a cybersecurity threat hunt request(s) from an analyst device 110 (e.g., an analyst), or receives a cybersecurity threat hunt request from a analyst device 110 via a gateway server.

The one or more SOAR platform server(s) 150 (e.g., electronic devices such as servers) can include a desktop, a laptop, a server, a cloud-based computing server farm, and the like. The one or more SOAR platform server(s) 150 receives and processes, via the cybersecurity threat hunting instruction set 160, a cybersecurity threat hunt request(s) from a analyst device 110 or customer device 105 directly, or receives a cybersecurity threat hunt request from a analyst device 110 via a gateway server to initiate an IOC hunt. In an exemplary implementation, once a customer is identified for a hunt campaign, an IOC hunt may be automatically in place and performed per a schedule (e.g., hourly, daily, weekly, etc.) and does not request a cybersecurity threat hunt request to initiate an IOC hunt. The cybersecurity threat hunting instruction set 160 includes a campaign module 162, a hunt module 164, an alert module 166, and one or more remediation modules 168.

The campaign module 162 may be utilized to create new customer campaign's using the IOCs ingested into the SOAR platform (e.g., automatically and iteratively-daily, hourly, etc.) from the intelligence feed database 132. The campaign module 162 may store and manage campaign rules associated with each customer in the campaign database 163. The campaign module 162 sends the IOC data to the hunt module 164. The hunt module 164 may be utilized to initiate an IOC hunt as described herein, and based on customer specific rules and associated data stored in a hunt database 165. The hunt module 164 searches (e.g., hunts) for any IOCs in customer data stored in one or more customer log database(s) 175 (e.g., separate anonymized and isolated containers for each customer). The alert module 166 may be utilized to determine and provide alerts on potential threats that are flagged and analyzed (e.g., confidence levels rated, commonalities between threats (e.g., industries), etc.), and store the alerts in the alert database 165. The remediation modules 168 may be utilized for performing and/or managing remedial actions by taking actions on machines where IOCs were found, e.g., automatically isolate the endpoint, disable user account, block IP sent to SOAR, and other remedial actions at a customer device 105 (e.g., a customer). The remediation modules 168 may also access the alert database 165 to analyze the alerts to determine and rate confidence levels, identify commonalities between threats (e.g., industries), and the like, before determining whether to initiate the one or more remedial actions described herein.

FIG. 1B illustrates an exemplary system flow diagram 100B for the exemplary system environment of FIG. 1A and FIG. 1C illustrates an exemplary flowchart of an example process for the system flow diagram of FIG. 1B, according to embodiments of the invention. In particular, the system flow diagram 100B and the flowchart 100C follow an example process for cybersecurity threat hunting based on the steps illustrated by blocks 180 thru block 188.

The cybersecurity threat hunting process begins at block 180 where threat intelligence (e.g., threat intelligence feed 134) is gathered from threat intelligence sources and sent to the campaign module 162 via the network 102. At block 182, the campaign module 162 creates IOCs from the threat intelligence feed 134 and stores the IOCs in the intelligence feed database 132. Further, at block 182, the campaign module 162 creates a campaign and stores the campaign in the campaign database 163, and sends IOC data to the hunt module 164.

At block 184, the hunt module 164 creates an IOC hunt to search customer logs databases for IOCs. For example, the hunt module 164 stores the IOC hunt data in the hunt database 165, accesses and searches one or more customer log database(s) 175 to search for IOCs based on the IOC data from the campaign module 162, identifies IOCs (“found IOCs”), and provides the found IOCs to the alert module 166.

At block 186, the alert module 166, for any found IOCs from the hunt module 164, creates alerts and sends the alerts and the found IOCs to the one or more remediation module(s) 168. The alert module 166 also stores the created alerts in the alert database 165. At block 188, the one or more remediation module(s) 168 may initiate remedial actions on machines (e.g., customer device(s) 105) where IOCs were found, and the alert module 166 provides the alerts to an analyst device 110 via network 102.

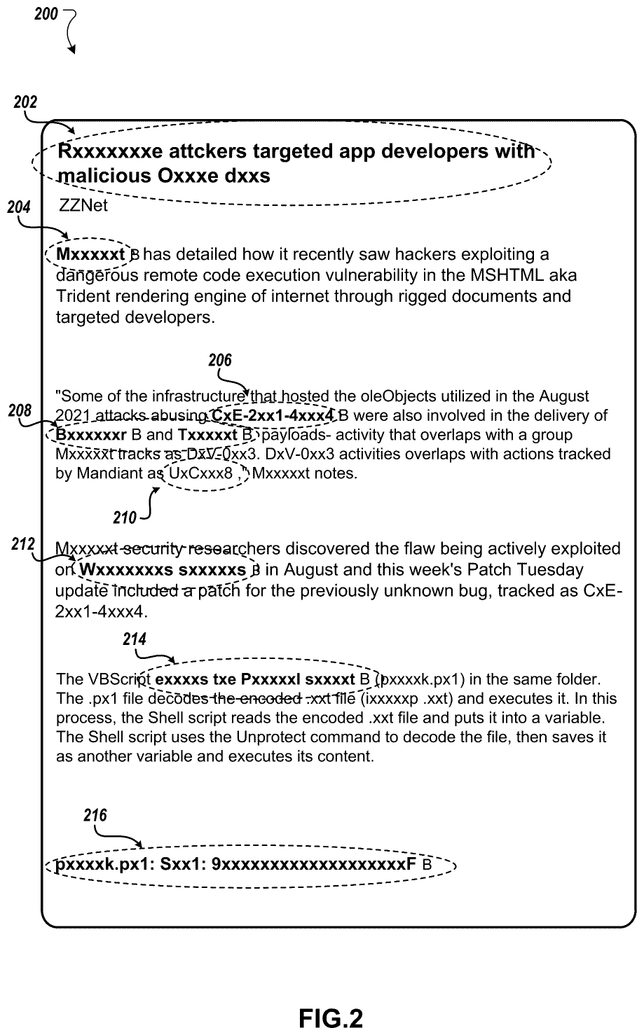

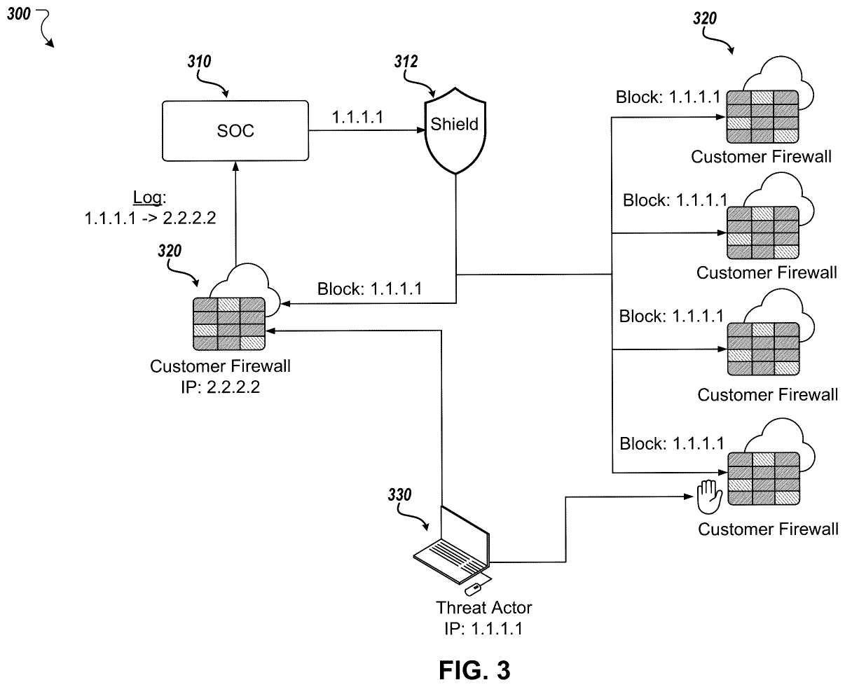

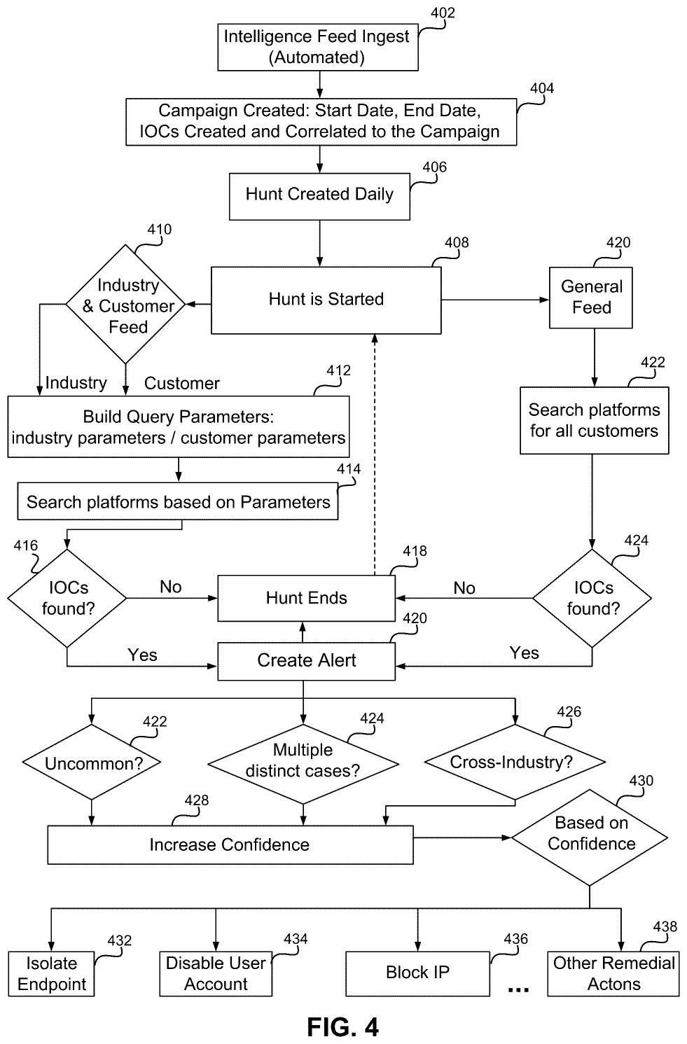

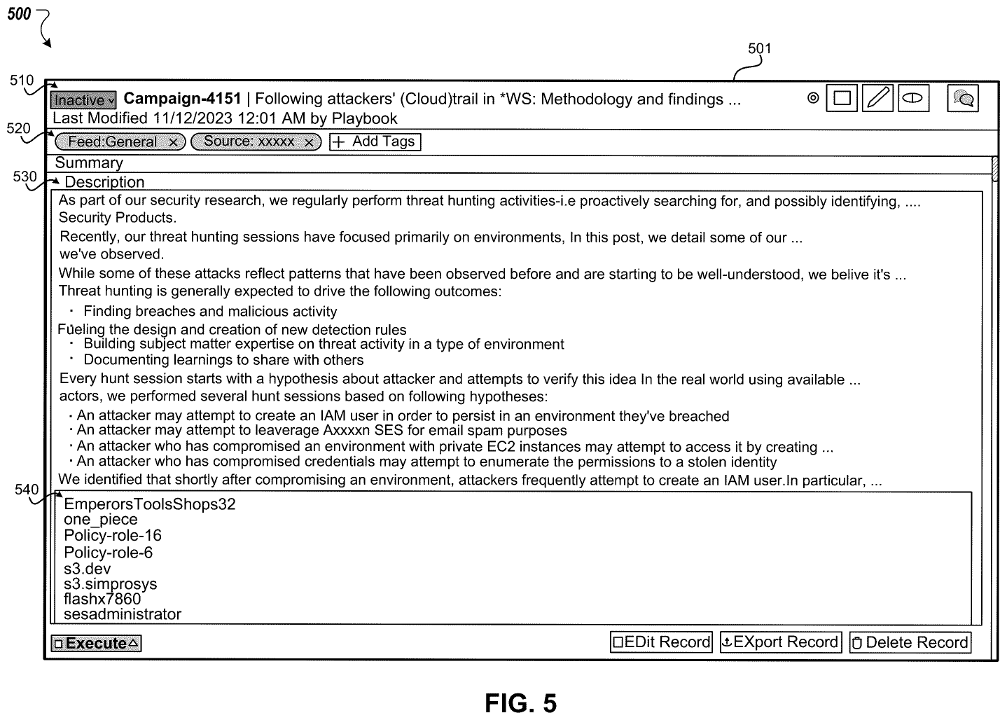

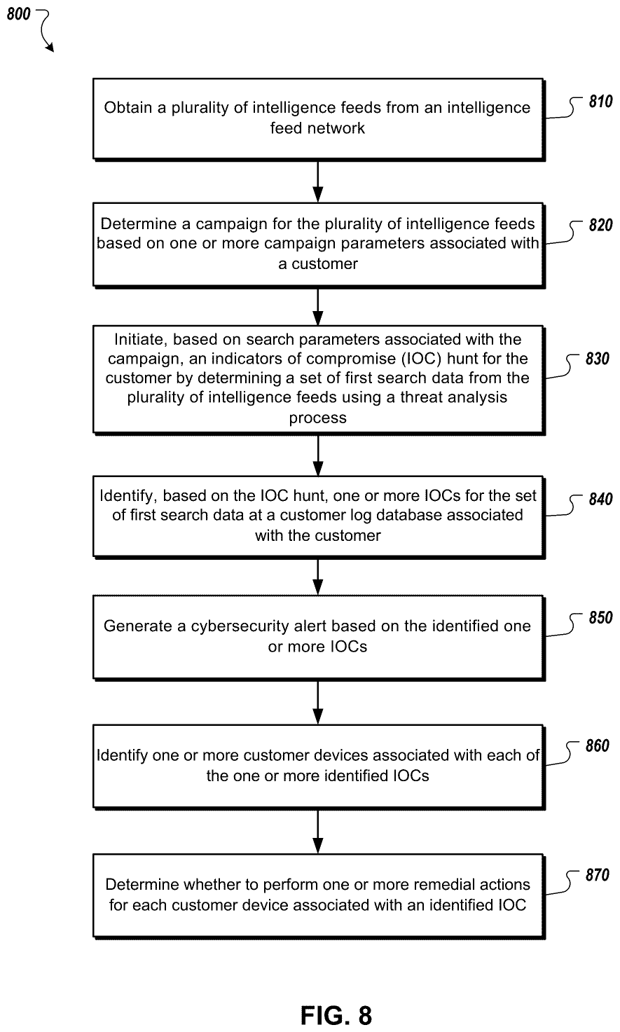

An example routine of implementing a cybersecurity threat hunting process as illustrated in FIGS. 1A-1C is further discussed herein with reference to the illustrations in FIGS. 2 and 3, the screenshots in FIGS. 5-7, and via the system/process flow diagrams of FIGS. 4 and 8.

FIG. 2 illustrates an example intelligence feed of a threat intelligence report document 200, according to embodiments of the invention. In particular, the threat intelligence report document 200 is an example cybersecurity web article (e.g., threat intelligence sources 135) that was analyzed by an intelligence feed server 130 and provided to a SOAR platform server 150 because of one or more flagged IOCs within the threat intelligence report document 200. The most prevalent portion of the threat intelligence report document 200 is the indicated IOC and associated relevant context at area 216 at the end of the threat report. Additionally, the threat intelligence report document 200 identifies other portions of the cybersecurity web article. For example, the threat intelligence report document 200 identifies the threat intelligence report title at area 202, an identified company associated with the threat at area 204 in the first section. The second section of the threat intelligence report document 200 includes an identified critical vulnerability at area 206, associated malware families at area 208, and an identification of a threat actor at area 210. The third section of the threat intelligence report document 200 includes the effect product at area 212, and the fourth section includes an example command and scripting interpreter at area 214.

FIG. 3 illustrates an example environment 300 for blocking an identified cybersecurity threat to a customer environment, according to embodiments of the invention. In particular, environment 300 illustrates an example shield firewall application 312 (e.g., for a SOAR platform server 150) that is communicatively coupled to an SOC 310 and a plurality of customer firewall access points 320. For example, after a threat actor 330 is identified in a threat intelligence report (e.g., an identification of a threat actor at area 210 of the threat intelligence report document 200), and based on the threat hunting processes described herein, the cybersecurity threat hunting instruction set 160 may be configured to identify and block the IP address associated with the identified threat actor 330 (e.g., IP: 1.1.1.1) from accessing the customer firewall 320 (e.g., IP: 2.2.2.2). For example, indicators may be determined to be malicious, and then all of the subscribed firewalls have ingested these new indicators and will begin to block them.

In sum, FIG. 3 illustrates blocking known-bad actors from communicating within a customer's network. In some implementations, a firewall can block an IP address via a firewall rule, if that IP address is the sender or receiver of the communication. However, some modern firewalls are even able to block IP addresses via DNS filtering that may be used to translate domain names into IP addresses (e.g., send a request to a DNS server with a “domain name” and receive a corresponding “IP address”). If a firewall has “DNS Filtering” capabilities, it means it has a mechanism to read, understand and filter DNS communication. This allows the firewall to drop traffic based on the IP address returned in the DNS response. At a high level, this means the firewall is able to block the traffic before the attempted communication even occurs. In some implementations, blocking network traffic based on a domain name requires the firewall to be monitoring web requests. These requests may be used in web browsers and other web request tools. Although most web traffic is encrypted (e.g., the communication is not readable by anyone except the two parties exchanging information), however, not everything is encrypted. One specific piece of information, the web headers, is not encrypted and therefore visible to anyone who can see the traffic pass by. One very important web header is the HOST header, which contains the domain name of the website a user is accessing.

FIG. 4 illustrates an example flow diagram of an example process 400 for cybersecurity threat hunting, according to embodiments of the invention. Operations of the cybersecurity threat hunting process 400 can be implemented, for example, by a system that includes one or more data processing apparatus, such as the one or more SOAR platform server(s) 150 of FIG. 1A. The cybersecurity threat hunting process 400 can also be implemented by instructions stored on computer storage medium (e.g., cybersecurity threat hunting instruction set 160), where execution of the instructions by a system that includes a data processing apparatus causes the data processing apparatus to perform the operations of the cybersecurity threat hunting process 400.

The cybersecurity threat hunting process 400 begins at block 402 where intelligence feeds are automatically ingested by at the SOAR platform (e.g., the one or more SOAR platform server(s) 150). At block 404, a campaign may be created and initiated using IOCs ingested into the SOAR platform (e.g., automatically and iteratively-daily, hourly, etc.), The campaign may include a start time (e.g., a current time) and an end date (e.g., set to 90 days from the start date). In some implementations, the ingested IOCs are created and correlated to the campaign and any campaign parameters.

At block 406, cybersecurity threat hunting process 400 initiates an IOC hunt that is created for the campaign. For example, a daily hunt process may begin and continue at a particular rate (e.g., daily, hourly, etc.) until the end of the campaign (e.g., 90 days).

The cybersecurity threat hunting process 400 continues where a hunt starts at block 408, and the search parameters vary based on the type of intelligence feed. Thus, at block 408, the hunt starts by determining the type of intelligence feed (e.g., industry, customer, or general). If the intelligence feed is an industry/customer feed, then the process 400 proceeds to decision block 410, but if the intelligence feed is determined to be a general feed, then the process 400 proceeds to block 420 for a general feed analysis. At decision block 410, the industry feeds and/or the customer feeds are identified from the industry/customer feed and sent to block 412 where each feed is determined to build associated query parameters for a search. For example, for an industry feed, it may be determined whether or not there are multiple customers involved (e.g., government), and for a customer feed, the query parameters may be specified for that specific customer. After the query parameters are built at block 412, the cybersecurity threat hunting process 400 continues to block 414 to perform a search in the different platforms based on the built parameters. For example, a search may be performed in an endpoint detection and response (EDR) platform, a search engine marketing (SEM) platform, and the like, based on the specified parameters for the identified industry and/or customer feed. At decision block 416, the cybersecurity threat hunting process 400 determines if any IOCs were found. If no IOCs were located, then the current hunt ends for that particular ingested feed at block 418; however, if IOCs were located, then an alert may be created for an analyst at block 420, as further discussed herein.

Returning back to the start of the hunt at block 408, if the intelligence feed is determined to be a general feed, then the cybersecurity threat hunting process 400 proceeds to block 420 for a general feed analysis. Thus, because the intelligence feed is a general feed, at block 422 the cybersecurity threat hunting process 400 performs a search in the different platforms (e.g., EDR platform, SEM platform, etc.) for all customers. At decision block 424, the cybersecurity threat hunting process 400 determines if any IOCs were found for the general feed. If no IOCs were located, then the current hunt ends for that particular ingested feed at block 418; however, if IOCs were located, then an alert may be created for an analyst at block 420.

After determining to create an alert may at block 420, the cybersecurity threat hunting process 400 continues an alert confidence analysis at decision blocks 422, 424, and 426 to determine a level of confidence to customize the alert. For example, at decision block 422 a determination is made as to whether the identified IOC that generated the alert analysis is uncommon (higher confidence level) or common (lower confidence level), at decision block 424 a determination is made as to whether the identified IOC that generated the alert analysis is also identified in other distinct cases, and at decision block 424 a determination is made as to whether the identified IOC that generated the alert analysis is found in different industries (e.g., commonalities between threats). Based on the alert confidence analysis at decision blocks 422, 424, and 426, a determination is made as to whether to increase the confidence level of the alert at block 428. After determining the confidence level of the alert at block 428, the cybersecurity threat hunting process 400 continues to decision block 430 and in response to determining that the cybersecurity threat level (e.g., confidence level) exceeds a threshold, the cybersecurity threat hunting process 400 may isolate an endpoint associated with the identified one or more IOCs (432), disable a user account associated with the identified one or more IOCs (434), block an IP address associated with the identified one or more IOCs (436), perform additional remedial actions with an entity associated with the identified one or more IOCs (438), or a combination thereof.

FIG. 5 illustrates an example screenshot 500 for cybersecurity threat hunting processes via a cybersecurity threat hunting user interface 501, according to embodiments of the invention. The example screenshot 500 illustrates generating an exemplary campaign from a campaign engine (e.g., campaign module 162). The cybersecurity threat hunting user interface 501 may be integrated with an end user (e.g., analyst) at a user device (e.g., analyst device 110) using an API (e.g., via API/UI module 168).

As illustrated in the example screenshot 500, the cybersecurity threat hunting user interface 501 may include a header section (e.g., UI section 510) which includes an overview of a current campaign (e.g., “Campaign 4151”) such as a current alert level status (e.g., “inactive), a modification timestamp, and other information. At UI section 520, different tags are illustrated to provide the user (e.g., analyst) with the current search parameters. For example, UI section 520 provides the current type of intelligence feed (e.g., general feed), and the current source of the intelligence feed (e.g., “Source: xxxxx”). At UI section 530, an overview description of the cybersecurity threat hunting is provided to the end user (e.g., an analyst). Section 540 illustrates an exemplary code section that may be associated with the current hunt or campaign of the cybersecurity threat hunting process.

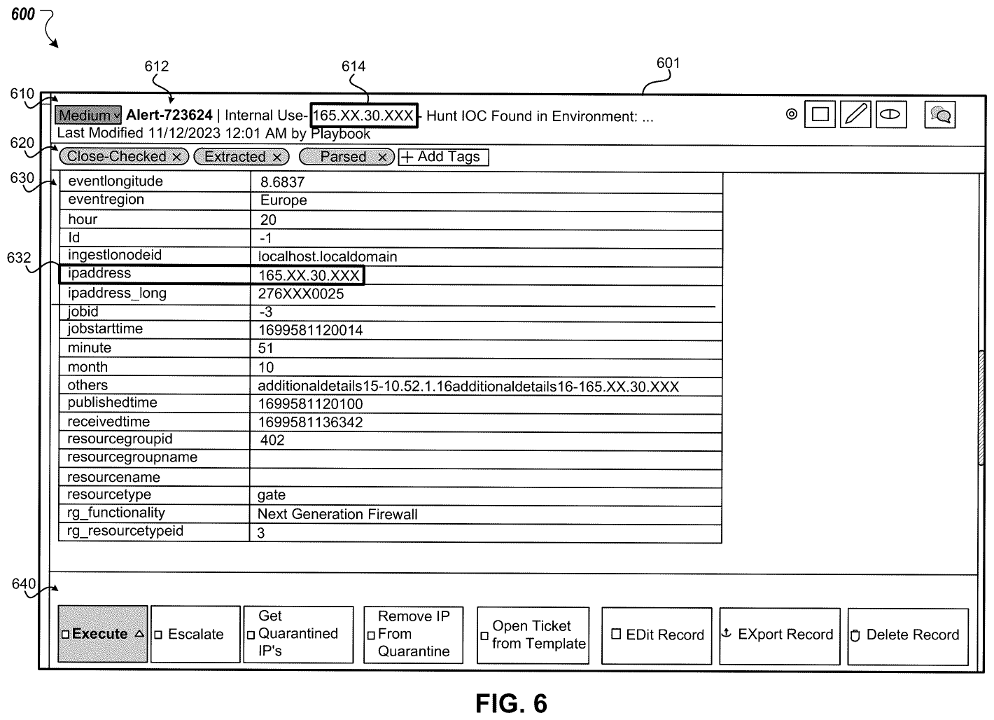

FIG. 6 illustrates an example screenshot 600 for cybersecurity threat hunting processes via a cybersecurity threat hunting user interface 601, according to embodiments of the invention. The example screenshot 600 illustrates generating an exemplary threat alert from a threat hunting engine (e.g., alert module 166 of the cybersecurity threat hunting instruction set 160). The cybersecurity threat hunting user interface 601 may be integrated with an end user (e.g., analyst) at a user device (e.g., analyst device 110) using an API (e.g., via API/UI module 168).

As illustrated in the example screenshot 600, the cybersecurity threat hunting user interface 601 may include a header section (e.g., UI section 510) which includes an overview of a current flagged IOC and an alert (e.g., “Alert-723624”) at UI element 612, a current alert level status (e.g., “Medium”), an identified IP address of the alert at UI element 614 (e.g., a highlighted threat indicator), a modification timestamp, and other information. At UI section 620, different tags are illustrated to provide the user (e.g., analyst) with the current search/query parameters associated with the indicated alert based on the current type of intelligence feed (e.g., general feed). For example, UI section 620 provides that the current query parameters include “close-checked”, “extracted”, and “parsed”. At UI section 630, details are provided for the indicated alert which includes highlighted threat indicator at UI element 614 (e.g., an indicated threat that is flagged to an analyst). UI section 640 illustrates a plurality of interactive icons associated with different tools available to an end user that may be associated with the current hunt or campaign of the cybersecurity threat hunting process.

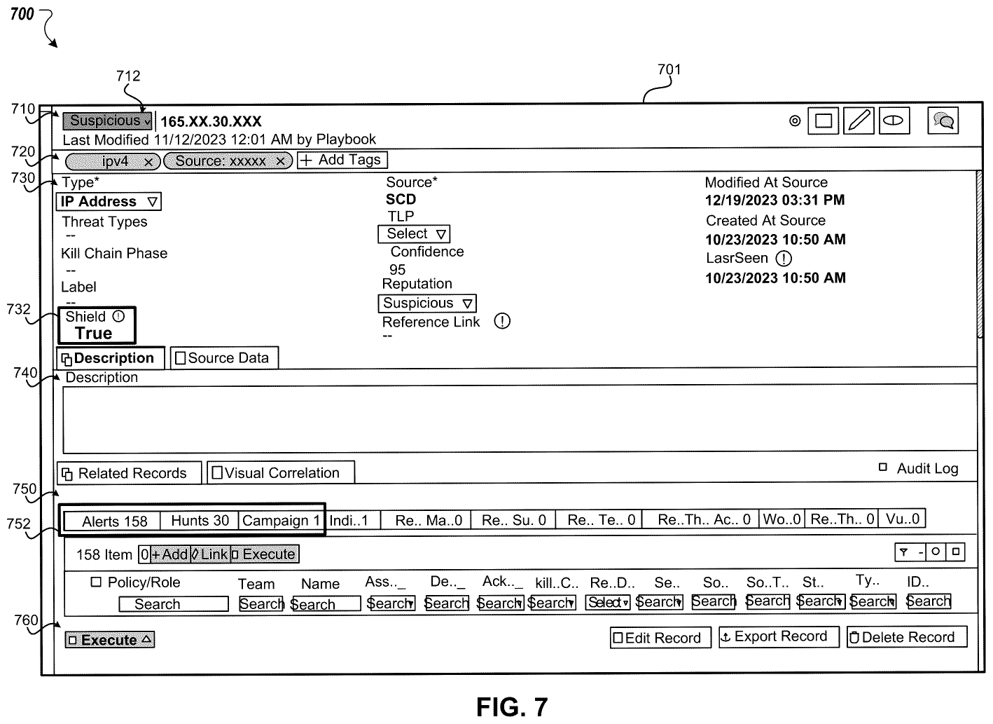

FIG. 7 illustrates an example screenshot 700 for cybersecurity threat hunting processes via a cybersecurity threat hunting user interface 701, according to embodiments of the invention. The example screenshot 700 illustrates an overview of an executed campaign from a threat hunting engine (e.g., the cybersecurity threat hunting instruction set 160). The cybersecurity threat hunting user interface 701 may be integrated with an end user (e.g., analyst) at a user device (e.g., analyst device 110) using an API (e.g., via API/UI module 168).

As illustrated in the example screenshot 700, the cybersecurity threat hunting user interface 701 may include a header section (e.g., UI section 510) which includes an overview of a current flagged IOC and an alert with a current alert level status (e.g., “Suspicious”) at UI element 712, an identified IP address of the alert, a modification timestamp, and other information associated with the campaign. At UI section 720, different tags are illustrated to provide the user (e.g., analyst) with the current intelligence feed sources or parameters associated with the campaign. For example, UI section 720 provides that the current query parameters include “ipv4” and the source (e.g., “Source: xxxxx”). At UI section 730, details are provided for the campaign and the indicated alert which includes highlighted threat indicator at UI element 732 that illustrates to the end user that the current suspicious threat was automatically blocked by the cybersecurity threat hunting process (e.g., a security shield was activated-“True”). At UI section 740, an overview description of the cybersecurity threat hunting may be provided to the end user (e.g., an analyst). At UI section 750, an overview description of the cybersecurity threat hunting campaign that is provided to the end user (e.g., an analyst). For example, UI area 752 highlights that for the one campaign, there were 30 hunts performed which generated 158 alerts. UI section 760 illustrates a plurality of interactive icons associated with different tools available to an end user that may be associated with the current hunt or campaign of the cybersecurity threat hunting process.

FIG. 8 illustrates a flowchart of an example process 800 for cybersecurity threat hunting, according to embodiments of the invention. Operations of the process 800 can be implemented, for example, by a system that includes one or more data processing apparatus, such as the one or more SOAR platform server(s) 150 of FIG. 1A. The process 800 can also be implemented by instructions stored on computer storage medium (e.g., cybersecurity threat hunting instruction set 160), where execution of the instructions by a system that includes a data processing apparatus causes the data processing apparatus to perform the operations of the process 800.

The system obtains a plurality of intelligence feeds from an intelligence feed network (810). For example, the cybersecurity threat hunting instruction set 160, stored on one or more SOAR platform server(s) 150, automatically (e.g., scheduled) and/or continuously obtains intelligence feeds, such as the example intelligence feed of a threat intelligence report document in FIG. 2. In some implementations, a trigger event, such as a request from customer or analyst, may initiate and trigger a new pull/download of the intelligence feeds (e.g., threat intelligence feed 134).

The system determines a campaign for the plurality of intelligence feeds based on one or more campaign parameters associated with a customer (820). For example, the cybersecurity threat hunting instruction set 160, stored on one or more SOAR platform server(s) 150 may create a campaign using IOCs ingested into the SOAR platform (e.g., automatically and iteratively—daily, hourly, etc.) as discussed herein.

The system initiates, based on search parameters associated with the campaign, an IOC hunt for the customer by determining a set of first search data from the plurality of intelligence feeds using a threat analysis process (830). For example, the cybersecurity threat hunting system may initiate a “hunt”, referred to herein as an “IOC hunt”. As illustrated by FIGS. 1A-1C, the IOC hunt, via the hunt module 164, is created to search customer logs databases 175 for IOCs. The hunt may be started for a particular time period (e.g., each day, hour, etc.). Moreover, the search parameters may vary based on the feed type, i.e., general, industry, customer, etc.

In some implementations, the one or more campaign parameters includes a hunt trigger event, and the IOC hunt is initiated based on the hunt trigger event (e.g., hunts are created daily/hourly for the next 90 days of a campaign). In some implementations, the hunt trigger event is based on a predetermined schedule, and wherein the IOC hunt is initiated for an identified timeframe (e.g., hunt is started for a particular time period (e.g., each day, hour, etc.). In some implementations, the hunt trigger event is based on receiving a cybersecurity threat hunt request from a user device (an analyst device) (e.g., a request for threat hunting based on receiving open-sourced intelligence feeds). For example, the system receives a cybersecurity threat hunt request from a user device. For example, the cybersecurity threat hunting instruction set 160, stored on one or more SOAR platform server(s) 150 may receive a cybersecurity threat hunt request from a requestor on a user device, such as an analyst. For example, the SOAR platform receives a request for threat hunting to initiate receiving open-sourced intelligence feeds of real-time filtered web traffic.

In some embodiments of the invention, initiating the IOC hunt for the customer by determining the set of first search data from the plurality of intelligence feeds using the threat analysis process initiates a cybersecurity threat hunt associated with the campaign and based on the one or more campaign parameters. In some embodiments of the invention, the cybersecurity threat hunt is initiated for an identified timeframe. For example, a hunt for a campaign may be created for a particular time period such as daily or hourly for the next 90 days of a campaign.

The system identifies, based on the IOC hunt, one or more IOCs for the set of first search data at a customer log database associated with the customer (840). For example, the system may identify the one or more IOCs for the set of first search data via the threat analysis process based on determining relevant IOC context associated with the plurality of intelligence feeds. In some implementations, the relevant IOC context includes an article link, malware information, information identifying a threat actor, common vulnerabilities and exposures (CVE) information, product information, an IP address, file hash information, a domain, a URL, detection signatures, an email address, network port data, registry key data, tactics, techniques, and procedures (TTP) information, or a combination thereof.

In some embodiments of the invention, determining the set of first search data from the plurality of intelligence feeds using the threat analysis process based on the search parameters associated with the campaign includes determining whether the intelligence feeds are associated with a first feed type or a second feed type that is different than the first feed type. In some embodiments of the invention, the first feed type includes an industry feed or a customer feed, and the second feed type includes a general feed. For example, as illustrated in FIG. 4, at block 408, at the onset of a hunt of a campaign, the intelligence feeds are separated based on industry or customer feeds as a first set of feeds, and the general feeds as a second set of feeds.

In some embodiments of the invention, in response to identifying the feed type as a first feed type (e.g., an industry feed or customer feed), the threat analysis process: i) builds query parameters based on an industry associated with the campaign, and ii) identifies search data repository platforms based on the query parameters. For example, as illustrated by the industry and customer feed block 410, an industry feed or customer feed, the system may build query parameters based on industry (e.g., block 412), and search data repository platforms based on the query parameters (e.g., block 424). In some embodiments of the invention, in response to identifying the feed type as a second feed type (e.g., a general feed), the threat analysis process identifies search data repository platforms. For example, as illustrated by the general feed block 420, if a general feed is identified, the search data repository platforms for all customers (e.g., block 422).

The system generates a cybersecurity alert based on the identified one or more IOCs (850). For example, the cybersecurity threat hunting analysis, via the alert module 166, flags and analyzes all alerts on potential threats, rates confidence levels, and determines commonalities (if any) between threats (e.g., industries).

The system identifies one or more customer devices associated with each of the one or more identified IOCs (860) and determines (e.g., by a remediation module 168) whether to perform one or more remedial actions for each customer device associated with an identified IOC (870). For example, the system may perform remedial actions by taking actions on machines where IOCs were found. In some implementations, the one or more remedial actions includes at least one of isolating an endpoint associated with each customer device, disabling a user account associated with each customer device, and blocking an IP address associated with a source of the identified one or more IOCs.

In some implementations, the system provides the cybersecurity alert to an application interface at the user device (e.g., analyst device 110). For example, as illustrated in screenshot 700 in FIG. 7, an alert is sent to an analyst.

In some embodiments of the invention, generating the cybersecurity alert based on the identified one or more IOCs includes determining commonality attributes associated with the identified one or more IOCs, and updating the cybersecurity alert based on the determined commonality attributes. For example, the SOAR platform may flag and analyze all alerts on potential threats, rate confidence levels, and determine commonalities between threats (e.g., industries), and the like.

In some embodiments of the invention, generating the cybersecurity alert based on the identified one or more IOCs includes determining a cybersecurity threat level based on the identified one or more IOCs, and updating the cybersecurity alert based on the determined cybersecurity threat level. For example, the SOAR platform may provide the alert to an analyst, and the alert process may also determine a confidence level for the alert.

In some embodiments of the invention, in response to determining that the cybersecurity threat level exceeds a threshold, the SOAR platform server is configured to isolate an endpoint associated with the identified one or more IOCs, disable a user account associated with the identified one or more IOCs, block an IP address associated with the identified one or more IOCs, perform additional remedial actions with an entity associated with the identified one or more IOCs, or a combination thereof. Additionally, the SOAR platform, based on the determined confidence level, may automatically isolate an endpoint, disable a user account, block an IP address sent to the SOAR platform or customer, and other remedial actions.

In some embodiments of the invention, generating the cybersecurity alert based on the identified one or more IOCs includes determining a type of cybersecurity threat based on the identified one or more IOCs, and updating the cybersecurity alert based on the determined type of cybersecurity threat. For example, the SOAR platform may provide the alert to an analyst. Additionally, the SOAR platform may also determine a type of alert such as uncommon, multiple similar alerts or distinct cases, cross-industry alerts, and the like.

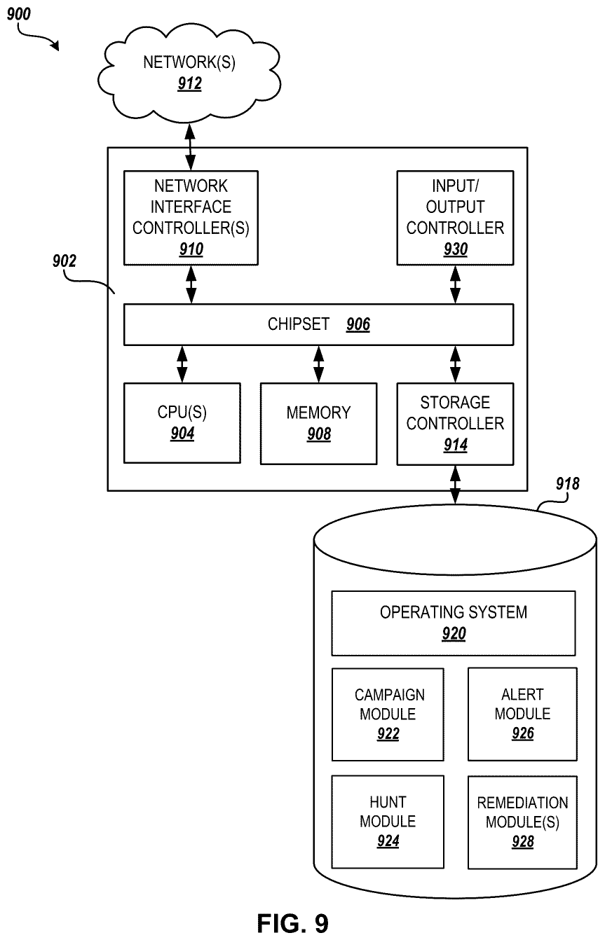

FIG. 9 illustrates an example computer architecture 900 for a computer 902 capable of executing the software components described herein for the sending/receiving and processing of tasks for the CA components. The computer architecture 900 (also referred to herein as a “server”) shown in FIG. 9 illustrates a server computer, workstation, desktop computer, laptop, or other computing device, and was utilized to execute any aspects of the software components presented herein described as executing on a host server, or other computing platform. The computer 902 preferably includes a baseboard, or “motherboard,” which is a printed circuit board to which a multitude of components or devices was connected by way of a communication bus or other electrical communication paths. In one illustrative embodiment, one or more central processing units (CPUs) 904 operate in conjunction with a chipset 906. The CPUs 904 can be programmable processors that perform arithmetic and logical operations necessary for the operation of the computer 902.

The CPUs 904 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements was combined to create more complex logic circuits, including registers, adders-subtractors, arithmetic logic units, floating-point units, or the like.

The chipset 906 provides an interface between the CPUs 904 and the remainder of the components and devices on the baseboard. The chipset 906 may provide an interface to a memory 908. The memory 908 may include a random-access memory (RAM) used as the main memory in the computer 902. The memory 908 may further include a computer-readable storage medium such as a read-only memory (ROM) or non-volatile RAM (NVRAM) for storing basic routines that that help to startup the computer 902 and to transfer information between the various components and devices. The ROM or NVRAM may also store other software components necessary for the operation of the computer 902 in accordance with the embodiments described herein.

According to various embodiments, the computer 902 may operate in a networked environment using logical connections to remote computing devices through one or more networks 912, a local-area network (LAN), a wide-area network (WAN), the Internet, or any other networking topology known in the art that connects the computer 902 to the devices and other remote computers. The chipset 906 includes functionality for providing network connectivity through one or more network interface controllers (NICs) 910, such as a gigabit Ethernet adapter. For example, the NIC 910 may be capable of connecting the computer 902 to other computer devices in the utility provider's systems. It should be appreciated that any number of NICs 910 may be present in the computer 902, connecting the computer to other types of networks and remote computer systems beyond those described herein.

The computer 902 may be connected to at least one mass storage device 918 that provides non-volatile storage for the computer 902. The mass storage device 918 may store system programs, application programs, other program modules, and data, which are described in greater detail herein. The mass storage device 918 may be connected to the computer 902 through a storage controller 914 connected to the chipset 906. The mass storage device 918 may consist of one or more physical storage units. The storage controller 914 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 902 may store data on the mass storage device 918 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 918 is characterized as primary or secondary storage, or the like. For example, the computer 902 may store information to the mass storage device 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 902 may further read information from the mass storage device 918 by detecting the physical states or characteristics of one or more particular locations within the physical storage units.

The mass storage device 918 may store an operating system 920 utilized to control the operation of the computer 902. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 918 may store other system or application programs and data utilized by the computer 902, such as a campaign module 922 (e.g., campaign model 162), a hunt module 924 (e.g., hunt module 164), an alert module 926 (e.g., alert model 166), and remediation module(s) 928 (e.g., remediation model(s) 168), according to embodiments described herein.

In some embodiments, the mass storage device 918 may be encoded with computer-executable instructions that, when loaded into the computer 902, transforms the computer 902 from being a general-purpose computing system into a special-purpose computer capable of implementing the embodiments described herein. These computer-executable instructions transform the computer 902 by specifying how the CPUs 904 transition between states, as described above. According to some embodiments, from the SOAR platform server(s) 150 perspective, the mass storage device 918 stores computer-executable instructions that, when executed by the computer 902, perform portions of the process 800, for implementing a cybersecurity threat hunting process, as described herein. In further embodiments, the computer 902 may have access to other computer-readable storage medium in addition to or as an alternative to the mass storage device 918.

The computer 902 may also include an input/output controller 930 for receiving and processing input from a number of input devices, such as a keyboard, a mouse, a touchpad, a touch screen, an electronic stylus, or other type of input device. Similarly, the input/output controller 930 may provide output to a display device, such as a computer monitor, a flat-panel display, a digital projector, a printer, a plotter, or other type of output device. It will be appreciated that the computer 902 may not include all of the components shown in FIG. 9, may include other components that are not explicitly shown in FIG. 9, or may utilize an architecture completely different than that shown in FIG. 9.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A computer-implemented method comprising:
at an electronic device associated with a security orchestration, automation, and response (SOAR) platform and having a processor:
obtaining a plurality of intelligence feeds from an intelligence feed network;
determining a campaign for the plurality of intelligence feeds based on one or more campaign parameters associated with a customer;
initiating, based on search parameters associated with the campaign, an indicator of compromise (IOC) hunt for the customer by determining a set of first search data from the plurality of intelligence feeds using a threat analysis process;
identifying, based on the IOC hunt, one or more IOCs for the set of first search data at a customer log database associated with the customer;
generating a cybersecurity alert based on the identified one or more IOCs;
identifying one or more customer devices associated with each of the one or more identified IOCs; and
determining whether to perform one or more remedial actions for each customer device associated with an identified IOC.

2. The computer-implemented method of claim 1, wherein the one or more remedial actions comprises at least one of:
isolating an endpoint associated with each customer device;
disabling a user account associated with each customer device; and
blocking an IP address associated with a source of the identified one or more IOCs.

3. The computer-implemented method of claim 1, further comprising:
providing the cybersecurity alert to an application interface at a user device.

4. The computer-implemented method of claim 1, wherein identifying the one or more IOCs for the set of first search data at the customer log database associated with the customer via the threat analysis process is based on determining relevant IOC context associated with the plurality of intelligence feeds.

5. The computer-implemented method of claim 4, wherein the relevant IOC context comprises an article link, malware information, a threat actor, common vulnerabilities and exposures (CVE) information, product information, an IP Address, file hash information, a domain, a URL, detection signatures, an email address, network port data, registry key data, tactics, techniques, and procedures (TTP) information, or a combination thereof.

6. The computer-implemented method of claim 1, wherein the one or more campaign parameters comprises a hunt trigger event, and wherein the IOC hunt is initiated based on the hunt trigger event.

7. The computer-implemented method of claim 6, wherein the hunt trigger event is based on a predetermined schedule, and wherein the IOC hunt is initiated for an identified timeframe.

8. The computer-implemented method of claim 6, wherein the hunt trigger event is based on receiving a cybersecurity threat hunt request from a user device.

9. The computer-implemented method of claim 1, wherein determining the set of first search data from the plurality of intelligence feeds using the threat analysis process based on the search parameters associated with the campaign comprises determining whether the intelligence feeds are associated with a first feed type or a second feed type that is different than the first feed type.

10. The computer-implemented method of claim 9, wherein, in response to identifying the feed type as a first feed type, the threat analysis process: i) builds query parameters based on an industry associated with the campaign, and ii) identifies search data repository platforms based on the query parameters.

11. The computer-implemented method of claim 9, wherein, in response to identifying the feed type as a second feed type, the threat analysis process identifies search data repository platforms.

12. The computer-implemented method of claim 9, wherein the first feed type comprises an industry feed or a customer feed, and wherein the second feed type comprises a general feed.

13. The computer-implemented method of claim 1, wherein generating the cybersecurity alert based on the identified one or more IOCs comprises:
determining commonality attributes associated with the identified one or more IOCs; and
updating the cybersecurity alert based on the determined commonality attributes.

14. The computer-implemented method of claim 1, wherein generating the cybersecurity alert based on the identified one or more IOCs comprises:
determining a cybersecurity threat level based on the identified one or more IOCs; and
updating the cybersecurity alert based on the determined cybersecurity threat level.

15. The computer-implemented method of claim 14, wherein, in response to determining that the cybersecurity threat level exceeds a threshold, the method further comprises:
isolating an endpoint associated with the identified one or more IOCs;
disabling a user account associated with the identified one or more IOCs;
blocking an IP address associated with the identified one or more IOCs;
performing additional remedial actions with an entity associated with the identified one or more IOCs; or
a combination thereof.

16. The computer-implemented method of claim 1, wherein generating the cybersecurity alert based on the identified one or more IOCs comprises:
determining a type of cybersecurity threat based on the identified one or more IOCs; and
updating the cybersecurity alert based on the determined type of cybersecurity threat.

17. A computing apparatus associated with a security orchestration, automation, and response (SOAR) platform, the computing apparatus comprising:
one or more processors;
at least one memory device coupled with the one or more processors; and
a data communications interface operably associated with the one or more processors, wherein the at least one memory device contains a plurality of program instructions that, when executed by the one or more processors, cause the one or more processors to perform operations comprising:
obtaining a plurality of intelligence feeds from an intelligence feed network;
determining a campaign for the plurality of intelligence feeds based on one or more campaign parameters associated with a customer;
initiating, based on search parameters associated with the campaign, an indicator of compromise (IOC) hunt for the customer by determining a set of first search data from the plurality of intelligence feeds using a threat analysis process;
identifying, based on the IOC hunt, one or more IOCs for the set of first search data at a customer log database associated with the customer;
generating a cybersecurity alert based on the identified one or more IOCs;
identifying one or more customer devices associated with each of the one or more identified IOCs; and
determining whether to perform one or more remedial actions for each customer device associated with an identified IOC.

18. The computing apparatus of claim 17, wherein the one or more remedial actions comprises at least one of:
isolating an endpoint associated with each customer device;
disabling a user account associated with each customer device; and
blocking an IP address associated with a source of the identified one or more IOCs.

19. The computing apparatus of claim 17, wherein identifying the one or more IOCs for the set of first search data at the customer log database associated with the customer via the threat analysis process is based on determining relevant IOC context associated with the plurality of intelligence feeds.

20. A non-transitory computer storage medium encoded with a computer program, the computer program comprising a plurality of program instructions that when executed by one or more processors cause the one or more processors to perform operations comprising:
obtaining a plurality of intelligence feeds from an intelligence feed network;
determining a campaign for the plurality of intelligence feeds based on one or more campaign parameters associated with a customer;
initiating, based on search parameters associated with the campaign, an indicator of compromise (IOC) hunt for the customer by determining a set of first search data from the plurality of intelligence feeds using a threat analysis process;
identifying, based on the IOC hunt, one or more IOCs for the set of first search data at a customer log database associated with the customer;
generating a cybersecurity alert based on the identified one or more IOCs;
identifying one or more customer devices associated with each of the one or more identified IOCs; and
determining whether to perform one or more remedial actions for each customer device associated with an identified IOC.
